(19) United States
(12) Patent Application Publication
(10) Pub. No.: US 2025/0275875 A1
(43) Pub. Date: Sep. 4, 2025

(54) CAREGIVER OPERATED MOBILITY SCOOTER DEVICE

(71) Applicant: Patrick C. Lynch, Lake Mary, FL (US)

(72) Inventor: Patrick C. Lynch, Lake Mary, FL (US)

(21) Appl. No.: 19/062,204

(22) Filed: Feb. 25, 2025

Related U.S. Application Data
(60) Provisional application No. 63/560,411, filed on Mar. 1, 2024.

(51) Int. Cl. A61G 5/10; A61G 5/04

(52) U.S. Cl. CPC A61G 5/1051; A61G 5/045; A61G 5/1005; A61G 2203/10

(57) ABSTRACT

A caregiver operated mobility scooter device includes an elongated main body having at least one front wheel and a pair of rear wheels. A user chair extends upward from the top surface of the main body, and an adjustable table is positioned between the chair and the front end of the main body. An operator control panel is positioned on a steering column that extends outward from the back end of the main body at a location behind the user chair. The control panel is operable by a caregiver walking behind the main body and includes functions for steering the scooter and operating a motor that is connected to the wheels.

### CROSS-REFERENCE TO RELATED APPLICATIONS

This application claims the benefit of U.S. Application Ser. No. 63/560,411 filed on Mar. 1, 2024, the contents of which are incorporated herein by reference.

### TECHNICAL FIELD

The present invention relates generally to the field of electric mobility scooters, and more particularly to a caregiver operated electric mobility scooter.

### BACKGROUND

The statements in this section merely provide background information related to the present disclosure and may not constitute prior art.

As medical breakthroughs continue to save and prolong lives, more people rely on powered mobility chairs each and every day. Some of these devices such as electric wheelchairs are intended to be used constantly by a chair occupant. As such, these devices are often custom built for the needs and body style of the intended occupant and are incredibly expensive to purchase. Conversely, scooter-type mobility chairs are intended to be used periodically, and are mass produced so as to be affordable to most individuals. For this reason, scooter-type mobility chairs are extremely popular as they allow disabled individuals the freedom to roam great distances from their homes or other locations utilizing a simplistic control and steering mechanism.

Although mobility scooters are designed to be relatively easy to operate, the fact remains that many individuals are unable to safely operate these devices. This is particularly true for small children and other individuals who may not grasp the potential danger and damage that can occur if/when they crash their scooter. As such, many disabled individuals are not able to benefit from the joy and freedom provided by a mobility scooter as they are limited to the ability of their caregivers to push them using a manual wheelchair.

The present invention, directed to a caregiver operated mobility scooter device differs from the conventional art in a number of aspects. The manner by which will become more apparent in the description which follows, particularly when read in conjunction with the accompanying drawings.

### SUMMARY OF THE INVENTION

The present invention is directed to a caregiver operated mobility scooter device. One embodiment of the present invention can include an elongated main body having at least one front wheel and a pair of rear wheels. A user chair can extend upward from the top surface of the main body, and an adjustable table can be positioned between the chair and the front end of the main body. An operator control panel is connected to a motor for driving the rear wheels.

In one embodiment, the operator control panel is connected onto a steering column that is located along the back end of the main body at a location behind the user chair. The steering column can include an adjustable angle for orienting the operator control panel to be suitable for use by a caregiver walking behind the main body. The user chair has restricted movement for preventing the chair occupant from accessing the operator control panel or otherwise controlling any operation of the scooter features.

The operator control panel can include a pair of handlebars to control the steering of the device, along with throttle and brake levers for controlling the speed of the motor and wheels. A user interface can be provided for allowing a caregiver to control other features of the mobility scooter.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a caregiver operated mobility scooter device, in accordance with one embodiment of the invention.

FIG. 2 is a side view of a caregiver operated mobility scooter device, in accordance with one embodiment of the invention.

FIG. 3 is a perspective view of a caregiver operated mobility scooter device in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As described herein, a “unit” means a series of identified physical components which are linked together and/or function together to perform a specified function.

As described throughout this document, the term “about” “approximately” “substantially” and “generally” shall be used interchangeably to describe a feature, shape, or measurement of a component within a tolerance such as, for example, manufacturing tolerances, measurement tolerances or the like.

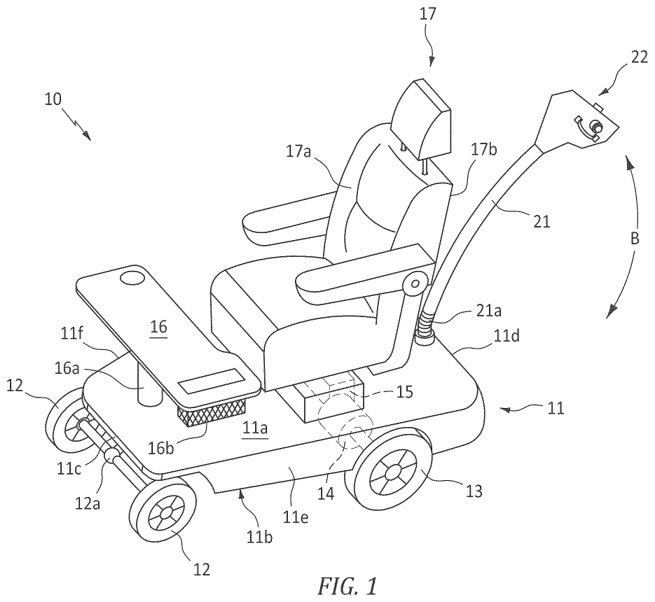

FIGS. 1-3 illustrate one embodiment of a caregiver operated mobility scooter device 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As shown in the drawings, the inventive device 10 can include, essentially, an elongated main body 11 having a table 16 a chair 17, and an operator panel 22 extending outward from the back end.

The main body 11 can include a top surface 11a, a bottom surface 11b, a front end 11c, a back end 11d and a pair of side surfaces 11e and 11f. The main body can include any number of different shapes and sizes and can be constructed from any number of materials that are, for example, relatively strong and stiff for their weight. Several nonlimiting examples include, but are not limited to various metals or metal alloys (e.g., aluminum, steel, titanium, or alloys thereof), plastic/polymers (e.g., high-density polyethylene (HDPE), rigid polyvinyl chloride (PVC)), and/or various composite materials (e.g., carbon fibers in a polymer matrix, fiberglass, etc.).

In one embodiment, the scooter can include at least one, but preferably two front wheels 12 that are connected to the operator panel 22 for steering, and a pair of rear wheels 13 that are connected to an electric motor 14 and the operator panel. One or more batteries 15 is provided for powering the electrical components. Although not illustrated, any suitable drivetrain may be provided for transmitting the rotational force of the motor to the wheels, and any number of shocks, springs and other known suspension components may be provided as are known in the art to act as an impact damping mechanism for aiding in the comfort of the user riding on the scooter.

In one embodiment, a table 16 can extend upward from the top surface 11a of the main body via an adjustable height stand 16a. As shown, the table can be located adjacent to the front end 11c of the scooter where the operator panel would normally be located. The table can include any number of different shapes and sizes and may include an optional basket 16b or other such components.

In one embodiment, a user chair 17 having a front end 17a and a back end 17b can extend upward from the top surface 11a of the main body. The chair can also include a pair of chair arms 17c that individually rotate up and down to permit easy ingress and egress by the user. In one embodiment (See FIG. 1), the chair is fixedly connected to the main body so that the front end 17a faces forward so as to always position a user in the forward-facing orientation (e.g., toward the front of the main body 11c).

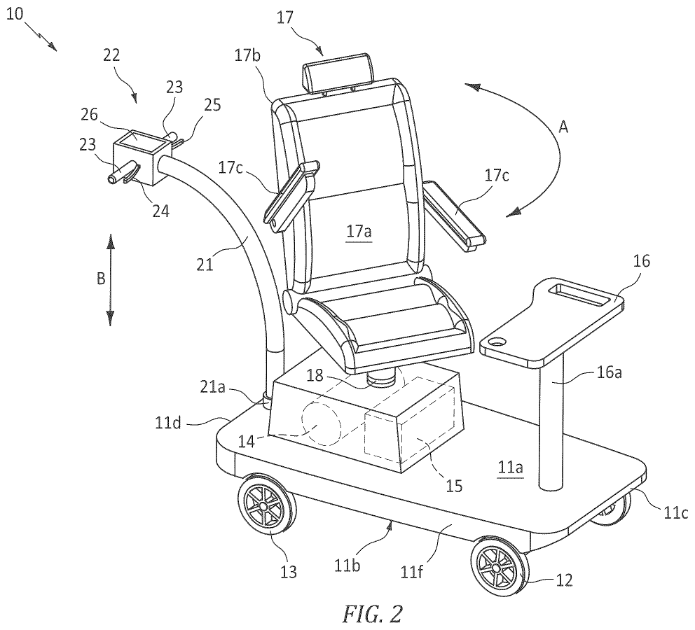

In one embodiment (See FIG. 2), the chair can be connected to the main body via a rotational bearing joint 18 or other such component that is limited to allow the chair to rotate no more than 45 degrees to either side of the forward orientation as shown by arrow A. Such a feature allowing the front of the chair 17a to diagonally face either side 11e or 11f of the main body to provide a user with the ability to easily access the chair from either side of the main body.

In either instance, it is important that the chair be unable to rotate more than 45 degrees from the forward orientation in either direction to ensure a user sitting in the chair is unable to reach or otherwise access the operator panel 22 and/or operate any of the device controls. Such a feature is critical, as the inventive device is designed specifically to be operated solely by a caregiver walking behind a user sitting in the chair of the scooter.

In one embodiment, a steering column 21 is connected to the back end 11d of the main body. In the preferred embodiment, the steering column can include a curvilinear-shaped housing and can extend outward and away from the back of the chair 17b and the back end 11d of the main body itself. Although the steering column may be fixed, it is preferred that the steering column include a hinge 21a or other suitable mechanism for providing a variable inclination to the column that allows a caregiver walking behind the scooter to adjust the height of the handlebars during operation as shown by arrow B.

In one embodiment, an operator control panel 22 can be positioned along the distal end of the steering column and can provide the sole means for controlling the operation of the scooter 10. In one embodiment, the operator panel can include a steering mechanism such as the illustrated handlebar grips 23 that are mechanically connected to the front wheels 12 via the steering column 21 and a rack and pinion mechanism 12a, for example, to allow a caregiver walking behind the main body to steer the scooter in any direction.

Of course, any number of other mechanical connections and/or steering means or mechanisms (e.g., joystick, steering wheel, etc.) are also contemplated. Additionally, some embodiments are contemplated wherein the handlebars are electrically connected to steering motors that are connected to the front wheels 12, to enable the scooter to operate in a steer-by-wire capacity so as to not rely on the mechanical steering mechanisms.

In one embodiment, a throttle lever 24 can be positioned along or adjacent to the handlebars. The throttle can be connected to the electric motor and can function in the expected manner to selectively move and stop the rear wheels 13, along with controlling the speed at which the scooter moves. In the preferred embodiment, the throttle will include an internal spring or other such device to bias the throttle lever in the stop position. Such a feature ensuring that if/when a user lets go of the throttle lever, the motor will slowly stop rotating the wheels and will prevent any movement of the wheels at all, thus acting as a brake.

In one embodiment, a dedicated brake lever 25 can also be positioned along or adjacent to the handlebars. The brake lever can be connected to physical brakes located along some or all of the wheels to stop or prevent movement of the scooter when the lever has been activated.

Although described and illustrated with regard to a 4-wheel scooter having rear wheels that are operated by the electric motor and front wheels that perform the steering, other embodiments and combinations are also contemplated. To this end, the inventive scooter may include a 3-wheel design and/or may also be configured in any combination where the rear wheel or wheels may control the steering and/or the front wheel or wheels are connected to the motor to move the scooter.

In either instance, a user interface 26 can be provided along or adjacent to the handlebars. The user interface 26 can include any number of physical switches, lights, display screens and/or may include a touchscreen display panel, for example. In either instance, the user interface can function to provide two-way communication with a user to allow the user to control the operation of the scooter. Several nonlimiting actions that can be performed by the user interface include but are not limited to providing a switch to selectively turning the scooter On or OFF, adjusting or limiting the speed at which the scooter can operate, turning headlights on or off, and/or to display the battery charge level, among other functions, for example.

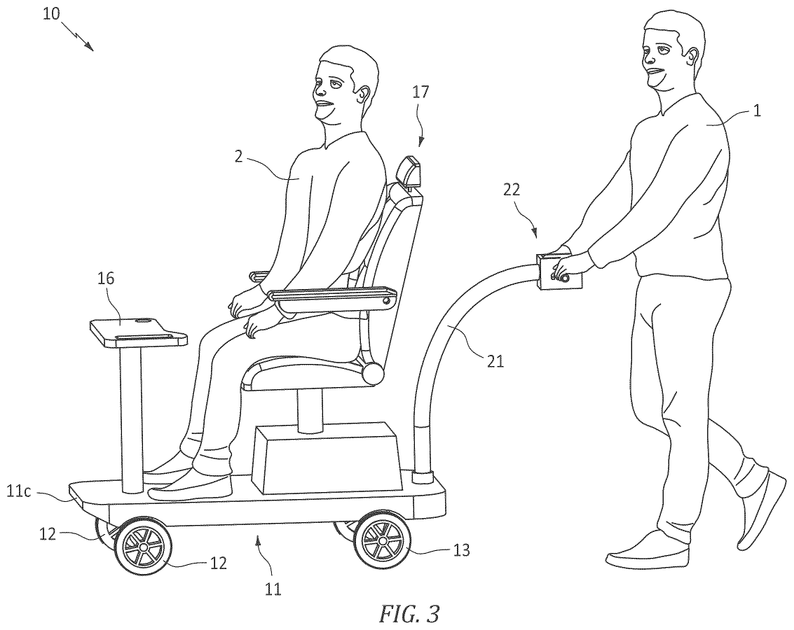

FIG. 3 illustrates one embodiment of the device 10 in operation. As shown, a caregiver 1 can walk behind the scooter and can utilize the operator control panel 22 to steer and drive the scooter in any direction while a user 2 sits safely and comfortably in the chair.

As to a further description of the manner and use of the present invention, the same should be apparent from the above description. Accordingly, no further discussion relating to the manner of usage and operation will be provided.

As described herein, one or more elements of the device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A mobility scooter device comprising:
a main body that extends in a longitudinal direction having two longitudinal sides, a front end, and a back end;
at least one front wheel that is connected to the main body;
a pair of rear wheels that are connected to the main body;
a motor that is connected to the pair of rear wheels;
a chair that is positioned along a top surface of the main body; and
an operator control panel that is connected to the motor.

2. The device of claim 1, wherein the chair includes a front end and a back end.

3. The device of claim 2, wherein the operator control panel is positioned adjacent to the back end of the chair.

4. The device of claim 1, wherein the operator control panel includes functionality for steering the at least one front wheel.

5. The device of claim 4, wherein the operator control panel includes a pair of handlebar grips.

6. The device of claim 4, wherein the operator control panel includes functionality for controlling an operation of the motor to selectively rotate the pair of rear wheels.

7. The device of claim 6, wherein the operator control panel includes a throttle lever.

8. The device of claim 4, wherein the operator control panel includes a brake lever.
